(19) United States
(12) Patent Application Publication
(10) Pub. No.: US 2018/0376358 A1
(43) Pub. Date: Dec. 27, 2018

(54) REMOTE MANAGEMENT OF BASE STATIONS AND/OR THE FUNCTIONS PERFORMED THEREBY

(71) Applicant: Tambora Systems Singapore Pte. Ltd., Singapore (SG)

(72) Inventors: Anand Uppili, Bangalore (IN); Edmond Capart, Monte Carlo (MC)

(21) Appl. No.: 16/012,030

(22) Filed: Jun. 19, 2018

(30) Foreign Application Priority Data
Jun. 22, 2017 (IN) 201741021993

(51) Int. Cl. H04W 24/04; H04L 12/24; H04W 88/18; H04W 92/12

(52) U.S. Cl. CPC H04W 24/04; H04W 92/12; H04W 88/18; H04L 41/048

(57) ABSTRACT

Embodiments described herein are directed to a control device that is configured to monitor parameter(s) associated with device(s) located at a site. The control device performs action(s) based on the monitored parameter(s). The control device sends command(s) to the device(s) that cause the device(s) to perform a certain function or operation based on the monitored parameter(s). The control device may also provide the parameters and/or other information provided by the device(s) to a centralized server for further monitoring and/or processing. The centralized server receives information from a plurality of control devices located at a plurality of different sites and provide commands to the control devices based on the received information. In addition, the control device determines whether a user device is connected to a base station or a wireless access point located at the site and provide/receive data in accordance with a data policy enforceable by the control device.

### CROSS-REFERENCE TO RELATED APPLICATION

This application claims priority to India Provisional Application Serial No. 201741021993, filed Jun. 22, 2017, and titled “Remote Management of Base Stations and/or the Functions Performed Thereby,” the entirety of which is incorporated by reference herein.

### BACKGROUND

### Technical Field

The subject matter described herein generally relates to remote monitoring and management of base stations and/or the functions performed thereby.

### Description of Related Art

There are various criteria that must be met to ensure that a base station is operating properly. For example, the base station should be powered properly, should be operating within certain temperatures, should be secure at all times, and the like. Typically, if one or more issues arise during operation of the base station, a site technician must be deployed to the base station to assess the problem and fix the issue. Given that the number of base stations within a given telecommunication network may be very large and that the number of base stations may be increasing, managing each base station is a difficult and resource-intensive challenge. Moreover, enforcing data limits and providing an acceptable level of service on a per-base station basis provides additional challenges.

### BRIEF SUMMARY

Methods, systems, and apparatuses are described for the remote monitoring and management of a base station and/or the functions performed thereby, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a system for the remote management of a base station site in accordance with an embodiment.

FIG. 2 is a block diagram of a system for enabling a base station site to serve as a wireless hotspot in accordance with an embodiment.

FIG. 3 is a block diagram of a control device in accordance with an embodiment.

FIG. 4 shows a flowchart of a method performed by a control device located at a base station site in accordance with an embodiment.

FIG. 5 is a block diagram of a system for the remote management of a base station site in accordance with another embodiment.

FIG. 6 shows a flowchart of a method performed by a control device for implementing a data policy at a base station site in accordance with an embodiment.

FIG. 7 is a block diagram of a system for implementing a data policy at a base station site in accordance with an embodiment.

FIG. 8 shows a flowchart of a method performed by a control device for implementing a data policy with respect to a wireless access point located at base station site in accordance with an embodiment.

FIG. 9 is a block diagram of a system for implementing a data policy with respect to a wireless access point located at base station site in accordance with an embodiment.

FIG. 10 shows a flowchart of a method performed by a control device for caching data in accordance with another embodiment.

FIG. 11 is a block diagram of a system for caching data in accordance with an embodiment.

FIG. 12 is a block diagram of a central analyzer in accordance with an embodiment.

FIG. 13 is a block diagram of an example computer system in which embodiments may be implemented.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### II. Example Embodiments

Embodiments described herein are directed to a control device that is configured to monitor one or more parameters associated with one or more devices located at a site (e.g., a base station site). The control device may perform one or more actions based on the monitored parameter(s). Such parameter(s) may include, but are not limited to, a temperature at or around the site, whether one or more doors providing access to the site have been opened and/or closed, an amount of power being consumed by the site, an amount of power being provided or that can be provided by a power source associated with the site, whether one or more devices located at the site is functioning properly, or the like. The control device may send one or more commands to the device(s) that cause the device(s) to perform a certain function or operation based on the monitored parameter(s). The control device may also provide the parameters and/or other information provided by the device(s) located at or associated with the site to a centralized server for further monitoring, processing and/or responsive action. The centralized server may be configured to receive information from a plurality of control devices located at a plurality of different sites and provide commands to the control devices based on the received information. The control devices may forward the commands to their respective associated device(s), thereby causing such device(s) to perform a certain function or operation. By doing so, characteristics of a plurality of base stations may be remotely monitored and controlled, thereby preventing the deployment of technicians to such sites each time an undesired situation occurs.

In addition, the control device is further configured to determine whether a user device is connected to a base station or a wireless access point and provide and/or receive data accordingly. For example, the control device may control the amount of bandwidth provided to the user device based on whether the user device is connected to the base station or a wireless access point. The control device may further perform metering functions that meter the traffic on a per-user, per-device, per-domain, and/or per-application basis. The foregoing may be performed in accordance with a data policy enforceable by the control device.

A. Base Station Site and Control Device Embodiments

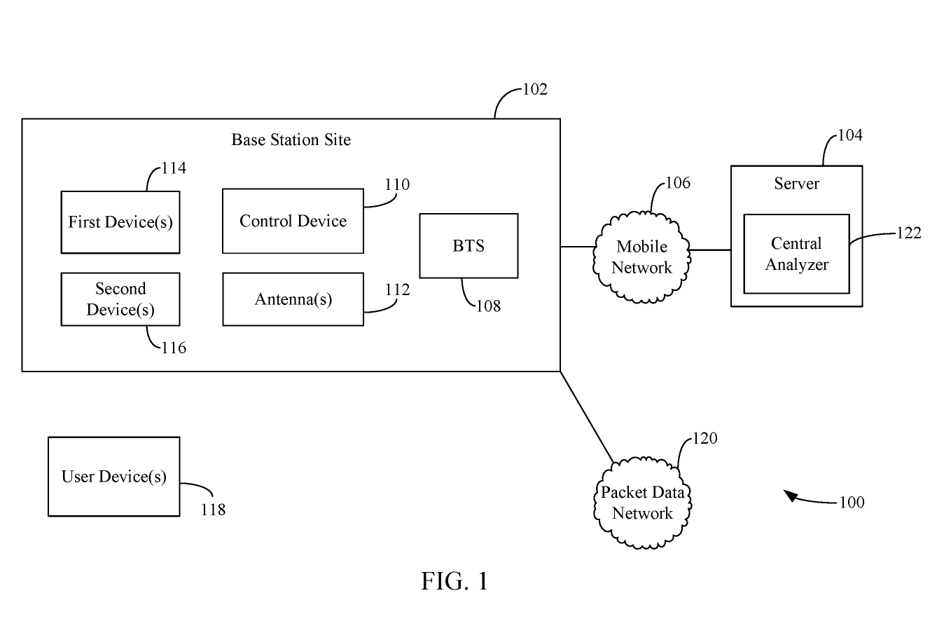

FIG. 1 is a block diagram of a system 100 for the remote management of a base station site 102 in accordance with an embodiment. As shown in FIG. 1, system 100 includes base station site 102 and a server 104 communicatively coupled via a mobile (e.g., “cellular”) network 106. Mobile network 106 may be managed by a mobile network operator (MNO). Base station site 102 includes a base transceiver station (BTS) 108, a control device 110, one or more antennas 112, one or more first devices 114 and one or more second device 116. BTS 108 may be configured to facilitate communication between one or more user devices 118 (also referred to as user equipment (UE) or mobile stations (MS)) and mobile network 106 and/or a packet data network 120 (e.g., the Internet). Examples of user device(s) 118 include, but are not limited to, a smart phone, a laptop, a tablet, etc.

BTS 108 may be configured to receive voice packets received from user device(s) 118 (located within one or more zones (e.g., geographical regions or cells) covered by BTS 108) via antenna(s) 112) and provide the received voice packets to mobile network 106. BTS 108 may transmit voice packets received from mobile network 106 to user device(s) 118 located within the zone(s) via antenna(s) 112. Mobile network 106 may also be utilized to transmit network entry messages, signaling information between different base stations located at different base station sites (e.g., to track movement of user device(s) 118 across different base stations, etc.), etc.

BTS 108 may be configured to receive data packets received from user device(s) 118 located within the zone(s) via antenna(s) 112 and provide the received data packets to packet data network 120. BTS 108 may transmit data packets received from packet data network 120 to user device(s) 118 located within the zone(s) via antenna(s) 112. The data packets may be internet protocol (IP)-based packets (e.g., hypertext transfer protocol (http) packets).

Antenna(s) 112 may be mounted on one or more towers (not shown). Mobile network 106 may be any cellular network, such as, a network based on Code Division Multiple Access (CDMA), Time Division Multiple Access (TDMA), Frequency Division Multiple Access (FDMA), Frequency Division Duplex (FDD), Global System for Mobile Communications (GSM), Wideband-CDMA (W-CDMA), Time Division Synchronous CDMA (TD-SCDMA), Long-Term Evolution (LTE), Time-Division Duplex LTE (TDD-LTE) system, and/or the like.

First device(s) 114 may comprise devices, apparatuses and/or equipment, which are used to maintain base station site 102. Examples of first device(s) 114 include, but are not limited to, one or more fans and/or an air-conditioning unit to maintain an appropriate temperature for base station site 102, one or more actuators to activate the fan(s), a thermostat to control the air-conditioning unit, one or more doors to provide entry into base station site 102, one or more actuators and/or locking mechanisms to close and/or lock the door(s), one or more power sources (e.g., an electrical grid, a battery backup, a diesel generator, one or more fuel cells or tanks, solar cell(s), etc.) to fuel and/or provide power to base station site 102 (and the equipment included therein (e.g., BTS 108, antenna(s) 112, control device 110, etc.), one or more pieces of monitoring equipment (e.g., a camera to record images and/or video), etc. The actuator(s) may comprise Internet-of-Things (IoT)-based actuators or devices and/or non-IoT-based actuators or devices.

Control device 110 may be configured to monitor parameters of first device(s) 114 and perform an action based on the monitored parameters. The parameters may be monitored via one or more second devices 116 that monitor base station site 102 and/or first device(s) 114. Examples of second device(s) 116 include, but are not limited to, one or more sensors (e.g., a fuel level sensor to detect an amount of fuel remaining in the fuel cell(s) or tank(s), a fuel tank lid sensor to detect whether a lid of a particular fuel tank is open, a lube oil pressure sensor to detect the oil pressure of a diesel generator, a diesel generator vibration sensor to determine whether the diesel generator is active, a temperature sensor to determine the temperature of base station site 102, a humidity sensor to determine the humidity of base station site 102, a motion sensor to determine whether a particular door has been opened or closed or to determine whether someone is located at base station site 102, a fire and/or smoke sensor to detect whether a fire has broken out at base station site 102, a voltage and/or current sensor to detect the voltage and/or current of any of the devices and/or equipment maintained in base station site 102, etc.). Second device(s) 116 may comprise Internet-of-Things (IoT) sensors or devices and/or non-IoT-based sensors or devices.

Control device 110 may be configured to determine one or more actions that are to be taken based on the monitored parameters. For example, control device 110 may cause an alert (e.g., an email message, a short message service (SMS) message, a notification rendered on a graphical user interface (GUI) executing on a computing device (e.g., server 104), etc.) to be transmitted to authorized personnel if a fire has broken out, the temperature or humidity of base station site 102 is too high (or low), whether a door is open, whether a fuel tank lid has been left open, whether fuel is low, etc. Control device 110 may also be configured to automatically determine and transmit a command to first device(s) 114 to cause first device(s) 114 to perform a desired action. For example, control device 110 may send a command to the thermostat and/or an air conditioning unit to change the temperature or humidity levels of base station site 102 in the event that the temperature or humidity levels are too high (or low), may send a command to the fan(s) (or actuator(s) thereof) to activate (or deactivate) the fan(s) to decrease the temperature of base station site 102, may send a command to a door's actuator that causes the door close (e.g., in the event that someone accidentally left it open) and to the door's locking mechanism that causes the door to lock, etc.

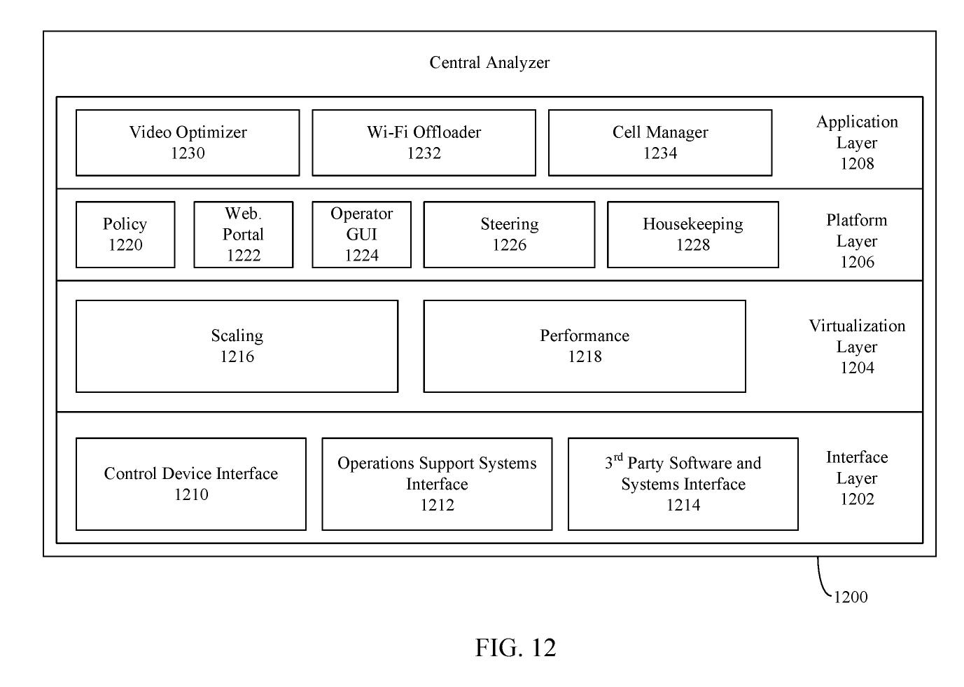

Control device 110 may also be configured to send the parameters to server 104 via mobile network 106 for analysis thereby. Server 104 may be configured to execute a central analyzer 122 that is configured to receive parameters received from a plurality of different control devices (e.g., control device 110) located at different base station sites (e.g., base station site 102). Central analyzer 122 may be configured to analyze the parameters and determine the appropriate action to be taken with respect to a particular base station site (e.g., sending an alert or determine the commands that are to be transmitted to second device(s) 116). For example, central analyzer 122 may send the determined command(s) to control device 110 via mobile network 106, and control device 110 may transmit the command(s) to first device(s) 114. Additional details regarding central analyzer 122 are described below with reference to FIG. 12. Server 104 may be located at a network operations center (NOC), a tower operations center (TOC) and/or a globalized network operations center (GNOC).

In accordance with an embodiment, control device 110 is communicatively coupled to BTS 108. In accordance with such an embodiment, voice and data packets received by BTS 108 from user device(s) 118 are provided to control device 110, which in turn provides the voice and data packets to mobile network 106 and packet data network 120, respectively. That is, control device 110 may selectively route voice packets to mobile network 106 and data packets to packet data network 120. Control device 110 may also be configured to receive voice and data packets from mobile network 106 and packet data network 120, respectively, and provide the voice and data packets to BTS 108. BTS 108 provides the voice and data packets to user device(s) 118 via antenna(s) 112. Control device 110 may be communicatively coupled to BTS 108 through an Ethernet or optical fiber cable, although the embodiments described herein are not so limited.

Control device 110 may be configured to implement a data policy with respect to the data being transmitted and/or received via packet data network 120. The data policy may be defined by the stakeholders (e.g., content providers) or it could operate in conjunction with a policy of mobile network 106, as defined by the MNO. The data policy may specify one or more metering rules for billing a user (e.g., a subscriber) associated with a particular user device of user device(s) 118 based on an amount of data downloaded by the user device via packet data network 120. Control device 110 may communicate with certain components of the mobile network 106 (such as the Online Charging System (OCS) and the Offline Charging System (OFCS) (not shown) of the MNO via the Gy and Gz interfaces) to properly bill a particular user.

In accordance with an embodiment, the metering rule(s) may vary application-to-application. For example, the data policy may specify a first set of rules for a first application executing on a particular user device of user device(s) 118 and specify a second set of rules for a second application executing on the user device. In accordance with another embodiment, the metering rule(s) may also vary domain-to-domain. For example, the data policy may specify a first set of rules for a first domain (e.g., website) accessible by a particular user device of user device(s) 118 and specify a second set of rules for a second domain accessible by the user device. In accordance with a further embodiment, the metering rule(s) may further vary user-to-user. For example, the data policy may specify a first set of rules for a first user and specify a second set of rules for a second user. Each of the first user and second user may be associated with any number of user device(s) 118. Thus, the metering rule(s) may determine an amount to bill a particular user based on an amount of data downloaded across all user device(s) 118 associated with that user. In accordance with yet another embodiment, the metering rule(s) may vary user device-to-user device. For example, the data policy may specify a first set of rules for a first user device of user device(s) 118 and specify a second set of rules for a second user device of user device(s) 118. In accordance with such an embodiment, a user may be associated with a plurality of user device(s) 118, but each user device is associated with its own set of metering rules.

The data policy may also specify the amount of bandwidth to be provided to a particular user device of user device(s) 118. For example, the data policy may widen or constrict the bandwidth provided to any individual traffic flow associated with a particular user device of user device(s) that utilizes packet data network 120.

Instead of control device 110 determining the data policy, as described above, central analyzer 122 may be configured to determine the policy and notify control device 110 of the policy to be utilized.

Control device 110 may also be configured to provide targeted information (e.g., advertisements) to a particular user device of user device(s) 118. For example, control device 110 and/or server 104 may maintain a database of user profile(s), where each user profile is associated with a particular user device. Control device 110 may obtain a unique identifier of a user device (e.g., an IP address) connected to BTS 108 and look up the user profile based on the unique identifier. The user profile may specify demographic information, a history of websites visited by the user using a particular user device, etc. Control device 110 may provide information targeted to the user based on the user profile(s).

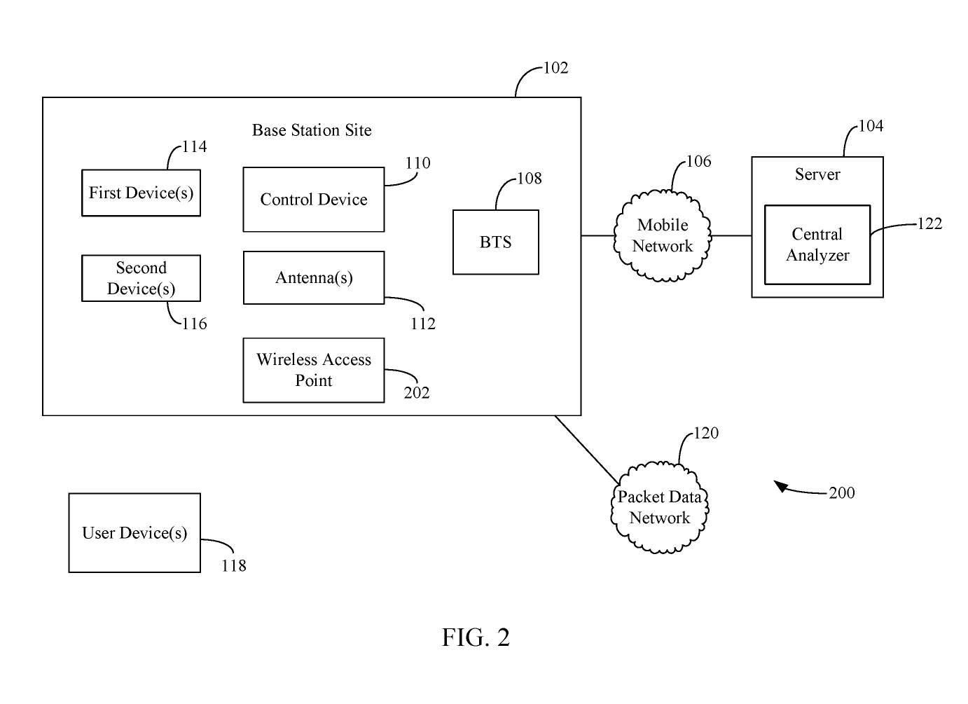

In accordance with an embodiment, base station site 102 may also include a wireless access point, thereby enabling base station site 102 to serve as a wireless hotspot. For example, FIG. 2 is a system 200 for enabling base station site 102 to serve as a wireless hotspot in accordance with an embodiment. As shown in FIG. 2, base station site 102 further includes a wireless access point 202. Wireless access point 202 may be a networking hardware device (e.g., a router, a gateway, etc.) that enables user device(s) 118 to connect to a wired or wireless network via a wireless connection (e.g., Wi-Fi), thereby enabling base station site 102 to serve as a hotspot. When user device(s) 118 come within proximity of wireless access point 202, user device(s) 118 switch from transmitting data to and receiving data from packet data network 120 and/or or mobile network 106 via BTS 108 to transmitting data to and receiving data via wireless access point 202. Such a process is also referred to as a local breakout.

Control device 110 may be communicatively coupled to wireless access point 202. Data packets received by wireless access point 202 from user device(s) 118 are provided to control device 110, and control device 110 provides the data packets to packet data network 120. Control device 110 may also be configured to receive data packets from packet data network 120 and provide such packets to wireless access point 202. Wireless access point 202 provides the data packets to user device(s) 118. Control device 110 may be communicatively coupled to wireless access point 202 through an Ethernet or optical fiber cable, although the embodiments described herein are not so limited.

Control device 110 may be configured to implement a data policy with respect to the data being transmitted and/or received via wireless access point 202. The data policy may be defined by the stakeholders (e.g., content providers) or it could operate in conjunction with a policy of mobile network 106, as defined by the MNO. The data policy may specify one or more metering rules for billing a user (e.g., a subscriber) associated with a particular user device of user device(s) 118 based on an amount of data downloaded by the user device via wireless access point 202. Control device 110 may communicate with certain components of the mobile network 106 (such as the Online Charging System (OCS) and the Offline Charging System (OFCS) (not shown) of the MNO via the Gy and Gz interfaces) to properly bill a particular user.

In accordance with an embodiment, the metering rule(s) may vary application-to-application, domain-to-domain, user-to-user and/or user device-to user device in a similar manner as described above.

The data policy may also specify the amount of bandwidth to be provided to a particular user device of user device(s) 118. For example, the data policy may widen or constrict the bandwidth provided to any individual traffic flow associated with a particular user device connected to wireless access point 202.

The data policy may further specify whether downloading data via wireless access point 202 affects a usage quota. For example, an MNO may specify a usage quota (e.g., a maximum amount of data that can be downloaded from a particular user device of user device(s) 118 via packet data network 120). Once the usage quota is met, the user device may no longer be able to download data or the user device may be only allowed to download data at a lower speed. The data policy may specify that data downloaded by a particular user device via wireless access point 202 does not count towards the usage quota. Alternatively, the data policy may specify that data downloaded by a particular user device via wireless access point 202 does count towards the usage quota.

Instead of control device 110 determining the data policy, as described above, central analyzer 122 may be configured to determine the policy and notify control device 110 of the policy to be utilized.

Control device 110 may also be configured to provide targeted information (e.g., advertisements) to a particular user device of user device(s) 118. For example, control device 110 and/or server 104 may maintain a database of user profile(s), where each user profile is associated with a particular device. Control device 110 may obtain a unique identifier of a user device (e.g., an IP address) connected to wireless access point 202 and look up the user profile based on the unique identifier. The user profile may specify demographic information, a history of websites visited by the user using a particular user device, etc. Control device 110 may provide information targeted to the user based on the user profile(s).

In accordance with an embodiment, control device 110 performs the authentication of a user attempting to connect to wireless access point 202. The authentication may be extensible authentication protocol (EAP)-based, although the embodiments described here are not so limited. To authenticate a user, control device 110 may obtain a unique identifier (e.g., a media access control (MAC) identifier of a particular user device of user device(s) 118) and retrieve user credentials (e.g., a username and/or password) associated with the unique identifier. Control device 110 may store user credentials in a memory stored therein. Alternatively, the user credentials may be stored in a data store located at base station site 102. Still further, the user credentials may be stored in a remotely-located data store maintained by the MNO (e.g., server 104). In such a case, control device 110 may obtain the user credentials via mobile network 106 or through a backbone network that communicatively couples control device 110 and the remotely-located data store.

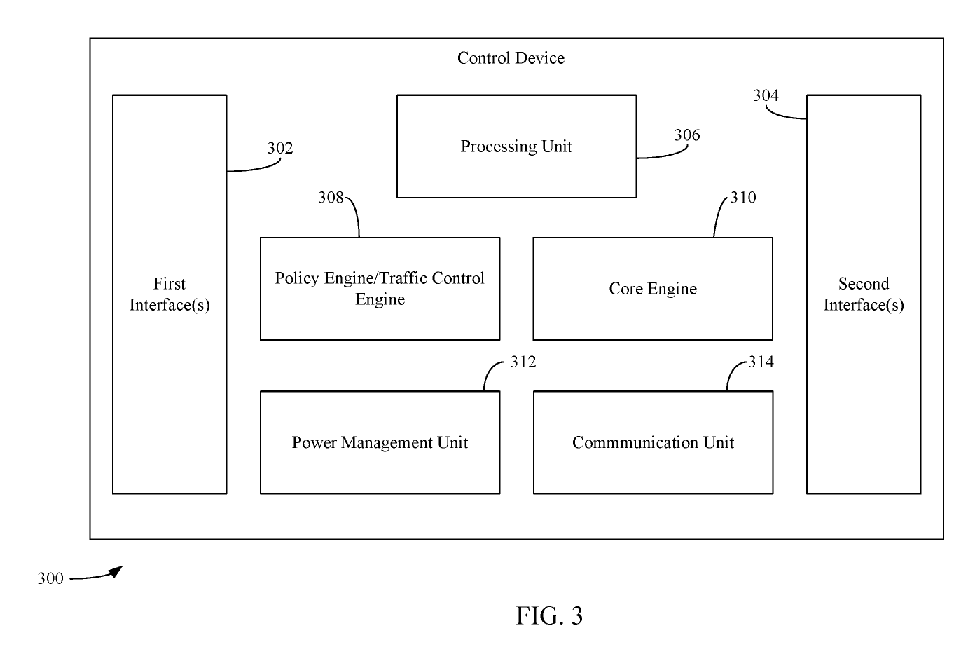

FIG. 3 is a block diagram of a control device 300 in accordance with an embodiment. Control device 300 is an example of control device 110, as described above with reference to FIGS. 1 and 2. Control device 300 may include one or more first interfaces 302, one or more second interfaces 304, a processing unit 306, a policy engine/traffic control engine 308, a core engine 310, a power management unit 312 and a communication unit 314. First interface(s) 302 may enable control device 300 to communicate with first device(s) 114 and/or second device(s) 116, as described above with reference to FIG. 1. First interface(s) 302 may also enable control device 300 to communicate with wireless access point 202, as described above with reference to FIG. 2. Each of first interface(s) 302 may be a wired interface or a wireless interface. Examples of a wired interface include, but are not limited to, a Universal Serial Bus (USB) interface, a coaxial interface, an Ethernet (e.g., registered jack (RJ)-45) interface, a recommended standard (RS)-232 interface, an RS-485 interface, an RS-422 interface, a Modbus interface, etc. Examples of a wireless interfaces include, but are not limited to, an infrared (IR) communication interface, a radio frequency (RF) communication interface (e.g., Bluetooth™, as described in the various standards developed and licensed by the Bluetooth™ Special Interest Group, technologies such as ZigBee® that are based on the IEEE 802.15.4 standard for wireless personal area networks, near field communication (NFC), other RF-based or internet protocol (IP)-based communication technologies such as any of the well-known IEEE 802.11 protocols, etc.) and/or the like.

The data or information (e.g., packets) received via first interface(s) 302 may be provided to processing unit 306. Processing unit 306 may comprise one or more processors (e.g., a central processing units, or CPUs, or other processing circuitry). Processing unit 306 may process and/or format the data into a format suitable for subsequent processing by core engine 310 and/or provides the processed and/or formatted data thereto.

Policy engine/traffic control engine 308 may be configured to perform functions such as packet forwarding for data plane traffic received from user device(s) (e.g., user device(s) 118, as shown in FIG. 1) to packet data network 120 (and vice versa) and/or the control and throttling of the data packets. Policy engine/traffic control engine 308 may also be configured to implement the data policy for data transmitted and received via BTS 108 and/or wireless access point 202, as described above with reference to FIGS. 1 and 2. For example, policy engine/traffic control engine 308 may perform metering functions that meters the data traffic of a particular user device (e.g., user device(s) 118) provided via BTS 108 and/or wireless access point 202, as described above with reference to FIGS. 1 and 2. Policy engine/traffic control engine 308 may further be configured to allocate bandwidth for user device(s) as described above with reference to FIGS. 1 and 2.

Core engine 310 may compare one or more monitored parameters received from second device(s) 116 via first interface(s) 302 with one or more predetermined thresholds. In the event that the threshold(s) are exceeded, core engine 310 may cause one or more commands to be sent to first device(s) 114 via first interface(s) 302. For example, core engine 310 may send command(s) to activate/deactivate an air-conditioning unit, one or more fans, etc. communicatively coupled to control device 300 based on whether the site being monitored is too hot or cold. In another example, core engine 310 may send command(s) to activate/deactivate a radiating or active element of antenna (e.g., antenna(s) 112) that are present on a base station site on which control device 110 is located (e.g., base station site 102). Core engine 310 may also perform basic housekeeping functionalities, such as, but not limited to, determining whether a particular device (e.g., first device(s) 114 and/or second device(s) 116) is active (e.g., by determining whether a periodic status signal (i.e., a “heartbeat”) is being received by such device(s)).

In accordance with an embodiment, core engine 310 may determine the command(s) locally. For example, control device 300 may maintain a data structure (e.g., a table) that associates different parameter thresholds to different actions that are to be performed by first device(s) 114. Such a table may be referred to as a parameter threshold-to-action mapping. For example, the mapping may indicate that if a monitored temperature is above a certain degree (e.g., 90 degrees), commands should be transmitted to a thermostat that cause an associated air-conditioning unit to be activated. In another example, the mapping may indicate that if a fuel tank lid sensor indicates that a fuel tank is left open, an alert should be transmitted to authorized personnel indicating that that the fuel tank lid is open. In accordance with another embodiment, core engine 310 may provide the monitored parameters to a centralized server (e.g., server 104, as shown in FIG. 1) via second interface(s) 304, and server 104 may determine the actions to be performed. For example, server 104 may determine command(s) to be performed by control device 300 and provide the commands to control device 300 via second interface(s) 304. Core engine 310 may translate the commands into a format suitable for processing by the devices that are to execute the commands (e.g., first device(s) 114). For example, second interface(s) may receive data in a format that is not compatible with first device(s) 114. Core engine 310 may translate the data into a format used by first device(s) 114 and provide the translated commands to first device(s) 114. First device(s) 114 execute the commands to perform the desired actions.

Second interface(s) 304 may be configured to transmit and/or receive data to and/or from server 104 via mobile network 106. The data may be transmitted and/or received in accordance with one or more protocols, including, but not limited to, a representational state transfer (REST or RESTful) protocol, a DIAMETER protocol (which provide Gx, Gy, Gz, Sd, and sTa interfaces), an OpenFlow protocol, a Simple Network Management Protocol (SNMP) protocol, etc. For example, information processed by one or more of processing unit 306 and/or policy engine/traffic control engine 308 may be formatted by core engine 310 in accordance with one or more of the above-described protocols. The formatted information is provided to second interface(s) 304, which transmits the information in accordance with one or more of the above-described protocols.

As described above with reference to FIG. 1, first device(s) 114 may comprise one or more power sources (e.g., via an electrical grid, a battery backup, a diesel generator, a fuel cell, solar cell(s), etc.). Power management unit 312 may be configured to perform power consumption optimization of the site on which control device is located. For example, power management unit 312 may monitor the power levels provided by the power source(s), determine whether a particular power source is providing inadequate power or whether a particular power source is costlier than another power source (given usage timings, etc.), and cause another power source of the power source(s) to provide power to the site. Power management unit 312 may utilize the parameter threshold-to-action mapping to determine the necessary action(s) to be carried out in the event that a particular power source is providing inadequate power (or whether a particular power source is costlier than another power source). For example, power management unit 312 may cause a command to be transmitted to a particular power source via first interface(s) 302 that causes that power source to be activated (or deactivated).

Communication unit 314 may comprise a ruggedized tamper-proof box that has at least one engraved subscriber identity module (SIMs) and/or an international mobile equipment identity (IMEI) that is activated by an operator over the air (e.g., OTA Activation of SIM). Communication unit 314 enables control device 300 to transmit data to the centralized server via mobile network 106.

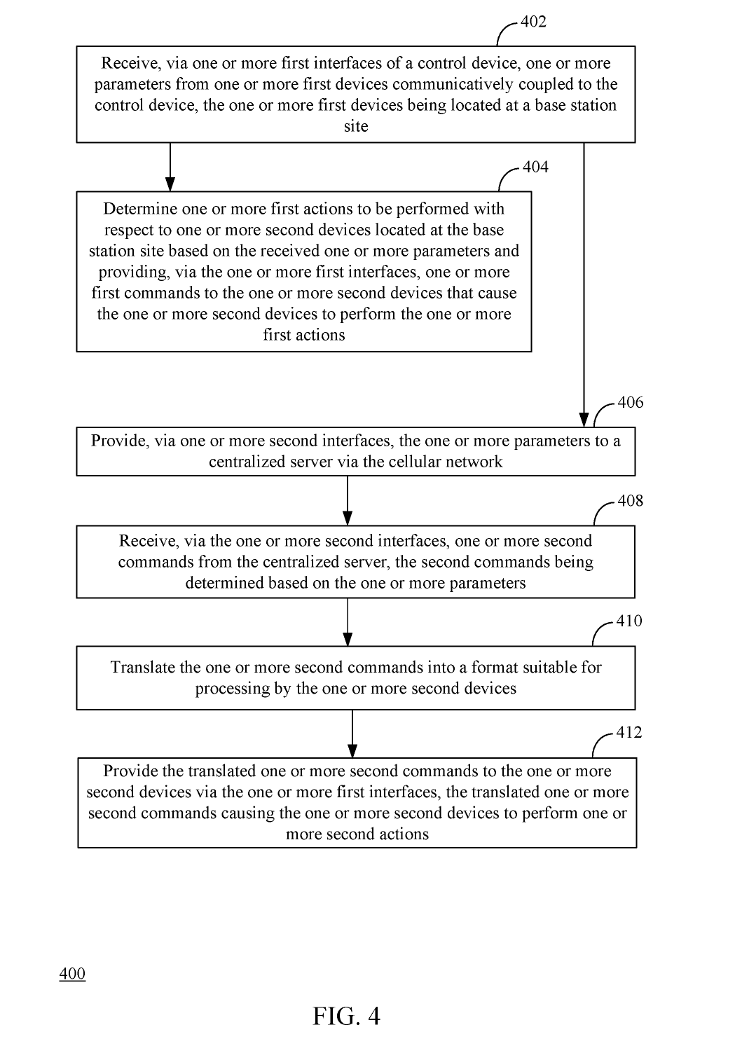

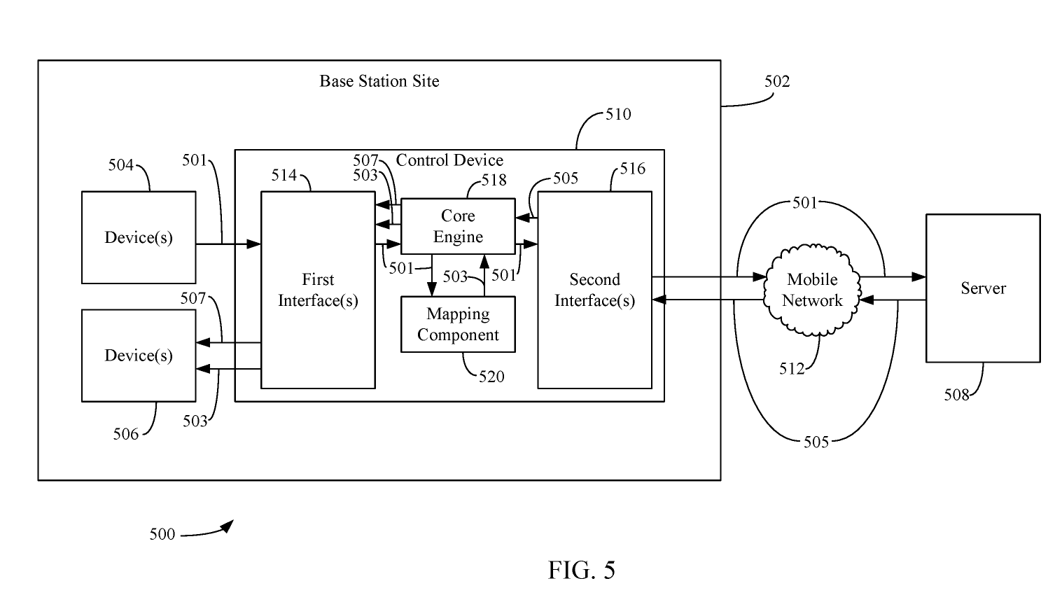

Accordingly, control device 110 may be configured to remotely manage a base station site in many ways. For example, FIG. 4 shows a flowchart 400 of a method performed by a control device located at a base station site in accordance with an embodiment. The method of flowchart 400 may be implemented by control device 510 shown in FIG. 5. FIG. 5 is a block diagram of a system 500 for the remote management of a base station site 502, in accordance with an embodiment. As shown in FIG. 5, system 500 includes control device 510, device(s) 504 and device(s) 506, each of which are located at base station site 502. System 500 further includes server 508, which is communicatively coupled to control device 510 via a mobile network 512. Base station site 502, control device 510, mobile network 512, and server 508, are examples of base station site 102, control device 110, mobile network 106 and server 104, as respectively described above with reference to FIGS. 1 and 2. Device(s) 504 are examples of second device(s) 116, and device(s) 506 are examples of first device(s) 114, as respectively described above with reference to FIG. 1. Control device 510 includes first interface(s) 514, second interface(s) 516, a core engine 518, and a mapping component 520. First interface(s) 514, second interface(s) 516 and core engine 518 are examples of first interface(s) 302, second interface(s) 304, and core engine 310, as respectively described above with reference to FIG. 3. Other structural and operational embodiments will be apparent to persons skilled in the relevant art(s) based on the following discussion regarding flowchart 400 and system 500 shown in FIG. 5.

Flowchart 400 begins with step 402. At step 402, parameter(s) are received from first device(s) communicatively coupled to the control device via first interface(s) of the control device, the first devices being located at the base station site. For example, with reference to FIG. 5, control device 510 receives parameter(s) 501 from devices(s) 504 via first interface(s) 514. Device(s) 504 are located at base station site 502. First interface(s) 514 provide parameter(s) 501 to core engine 518.

In accordance with one or more embodiments, the first interface(s) comprise at least one or more of a USB interface, a coaxial interface, an Ethernet interface, an RS-232 interface, an RS-485 interface, an RS-422 interface, a Modbus interface, an IR communication interface, a Bluetooth™ communication interface, a ZigBee® communication interface, an RF-based communication interface, or a wireless local area network-based interface.

In accordance with one or more embodiments, the first device(s) (i.e., device(s) 504) comprise at least one or more of a fuel level sensor, a fuel tank lid sensor, a lube oil pressure sensor, a diesel generator vibration sensor, a temperature sensor, a voltage sensor, a current sensor, a humidity sensor, a motion sensor, a fire sensor, or a smoke sensor.

Control device 510 may be configured to determine first action(s) to be performed with respect to one or more second device(s). For example, at step 404, first action(s) to be performed with respect to second device(s) located at the base station site are determined based on the received parameter(s), and first command(s) are provided to the second device(s) via the first interface(s) that cause the second device(s) to perform the first action(s). For example, with reference to FIG. 5, core engine 518 provides parameter(s) 501 to mapping component 520, which maintains a parameter threshold-to-action mapping, and mapping component 520 returns commands(s) 503 to be performed with respect to device(s) 506 to core engine 518. Core engine 518 provides command(s) 503 to first interface(s) 514, and first interface(s) 514 provide command(s) 503 to device(s) 506.

In accordance with one or more embodiments, the first command(s) are provided to the second device(s) responsive to the received parameter(s) exceeding a predetermined threshold.

In addition to, or in lieu of performing step 404, control device 510 may provide the parameters to server 508, which determines the commands that are to be provided to device(s) 506. The foregoing is described below with reference to steps 406, 408, 410 and 412.

At step 406, the parameter(s) are provided via second interface(s) to a centralized server via the mobile network. For example, with reference to FIG. 5, control device 510 provides parameter(s) 501 to second interface(s) 516, which provides parameters 501 to server 508 via mobile network 512.

In accordance with one or more embodiments, the second interface(s) comprise at least one or more of a REST protocol-based interface, a DIAMETER protocol-based interface, an OpenFlow protocol-based interface, or an SNMP protocol-based interface.

At step 408, second command(s) are received from the centralized server via the second interface(s), the second commands being determined based on the one or more parameters. For example, with reference to FIG. 5, second interface(s) 516 receives second command(s) 505 from server 508. Second interface(s) 516 provides second command(s) 505 to core engine 518.

At step 410, the second command(s) are translated into a format suitable for processing by the second device(s). For example, with reference to FIG. 5, core engine 518 translates second command(s) 505 into a format suitable for processing by device(s) 506.

At step 412, the translated second command(s) are provided to the second device(s) via the first interface(s), the translated second command(s) causing the second device(s) to perform second action(s). For example, with reference to FIG. 5, control device 510 provides translated second command(s) 507 to device(s) 506 via first interface(s) 514.

In accordance with one or more embodiments, the centralized server is communicatively coupled to a plurality of control devices, each of the plurality of control devices being located at a respective base station site.

In accordance with one or more embodiment, the second device(s) comprise at least one or more of a camera, a fan, a door, a thermostat, an air conditioning unit, a generator, or an antenna.

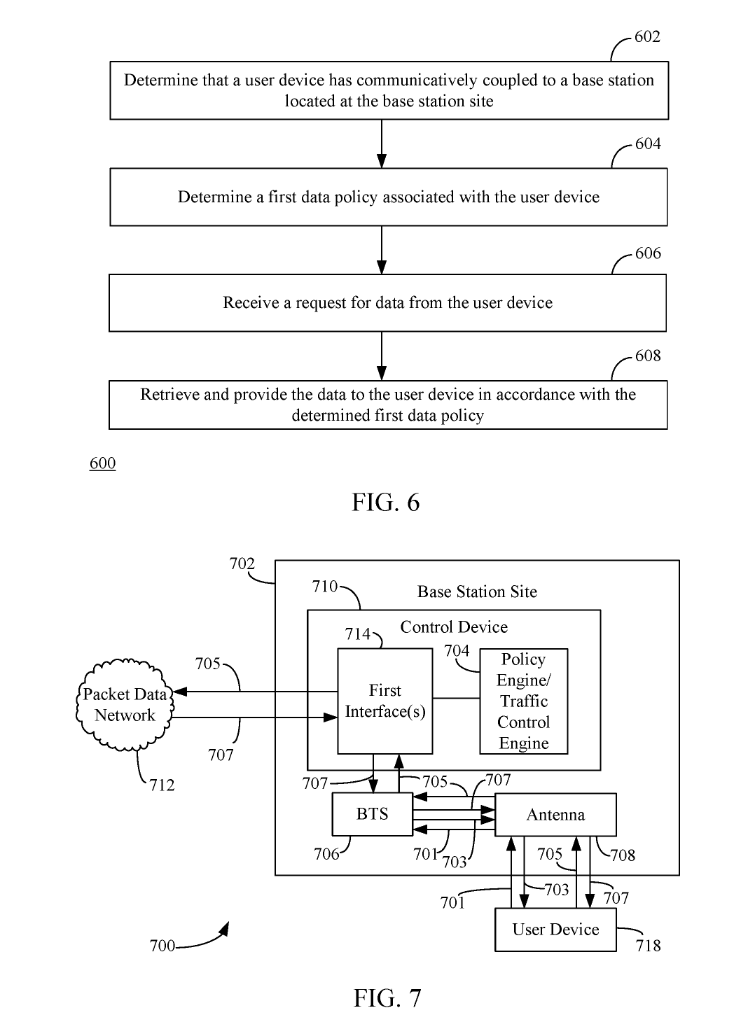

FIG. 6 shows a flowchart 600 of a method performed by a control device for implementing a data policy at a base station site in accordance with an embodiment. The method of flowchart 600 may be implemented by a control device 710 shown in FIG. 7. FIG. 7 is a block diagram of a system 700 for implementing a data policy at a base station site 702, in accordance with an embodiment. As shown in FIG. 7, system 700 includes control device 710, a BTS 706, an antenna 708, and a user device 718. Control device 710, BTS 706, and antenna 708, are located at base station site 702. Control device 710 is communicatively coupled to a packet data network 712 via first interface(s) 714. Base station site 702, control device 710, packet data network 712, and user device 718, are examples of base station site 102, control device 110, packet data network 120, and user device 118, as respectively described above with reference to FIGS. 1 and 2. Control device 710 includes, first interface(s) 714 and policy engine/traffic control engine 704. First interface(s) 714 and policy engine/traffic control engine 704 are examples of first interface(s) 302 and policy engine/traffic control engine 308, as respectively described above with reference to FIG. 3. Other structural and operational embodiments will be apparent to persons skilled in the relevant art(s) based on the following discussion regarding flowchart 600 and system 700 shown in FIG. 7.

Flowchart 600 begins with step 602. At step 602, a determination is made that a user device has communicatively coupled to a base station located at the base station site. For example, with reference to FIG. 7, control device 710 may determine that user device 718 is communicatively coupled to BTS 706 located at base station site 702. For example, BTS 706 may receive one or more registration request messages 701 from user device 718 via antenna 708 and, upon successful registration, provide a registration access message 703 to user device 718 via antenna 708. BTS 706 may determine that user device 718 is communicatively coupled to BTS 706 upon transmission of registration access message 703.

At step 604, a first data policy is associated with the user device is determined. For example, with reference to FIG. 7, policy engine/traffic control engine 704 may determine the first data policy associated with user device 718. For example, the registration access message may include the MAC ID of user device 718. Policy engine/traffic control engine 704 may access a database that associates data polic(ies) with different user device(s) using such an ID to determine the first data policy. The database may be stored by control device 710 or in a data store maintained by base station site 702. Alternatively, the database may be remotely located a server (e.g., server 104) and control device 710 may access the server to obtain the first data policy.

At step 606, a request for data is received from the user device. For example, with reference to FIG. 7, user device 718 may send a data request 705 to BTS 706 via antenna 708. BTS 706 provides data request 705 to control device via first interface(s) 714. First interface(s) 714 provides data request 705 to packet data network 712.

At step 608, the data is retrieved and provided to the user device in accordance with the determined first data policy. For example, packet data network 712 provides a response 707 that includes the data to control device 710 via first interface(s) 714. First interface(s) 714 provides response 707 to BTS 706 in accordance with the data policy determined by policy engine/traffic control engine 704. BTS 706 provides response 707 to user device 718 via antenna 708.

In accordance with one or more embodiments, the first data policy specifies at least an amount of bandwidth to be allocated to the user device when accessing data or one or more metering rules for billing a subscriber associated with the user device based on an amount of data downloaded by the user device.

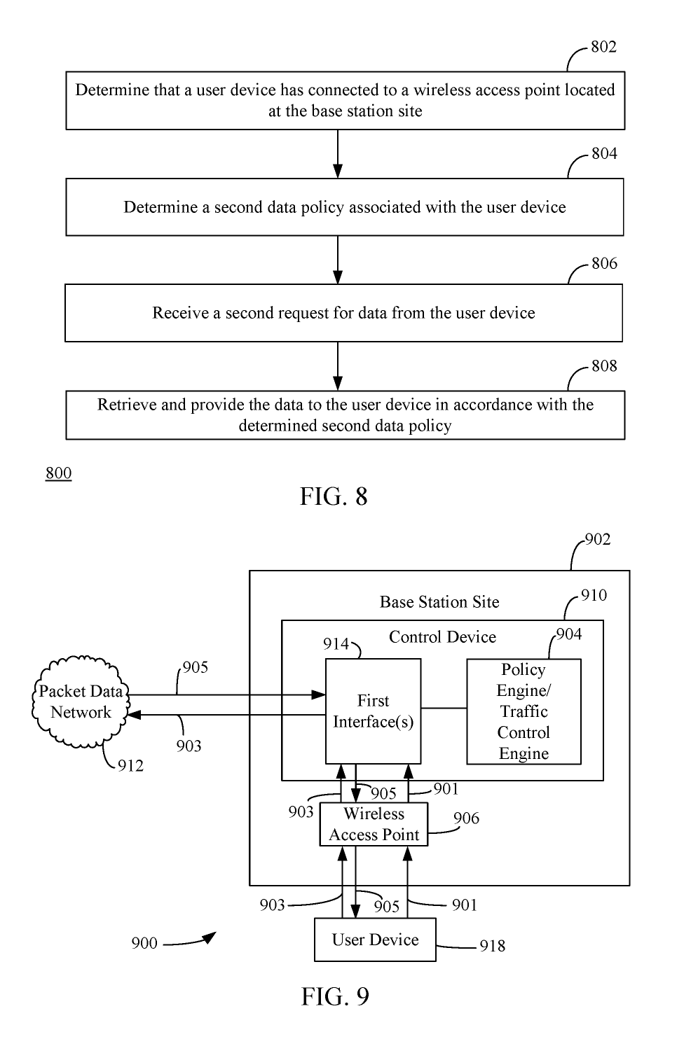

In accordance with one or more embodiments, the control device may implement a data policy with respect to a wireless access point located at the base station site. For example, FIG. 8 shows a flowchart 800 of a method performed by a control device for implementing a data policy with respect to a wireless access point located at base station site in accordance with an embodiment. The method of flowchart 800 may be implemented by control device 910 shown in FIG. 9. FIG. 9 is a block diagram of a system 900 for implementing a data policy with respect to a wireless access point located at a base station site, in accordance with another embodiment. As shown in FIG. 9, system 900 includes control device 910, a wireless access point 906 and a user device 918. Control device 910 and wireless access point 906 are located at base station site 902. Control device 910 is communicatively coupled to a packet data network 912. Base station site 902, control device 910, packet data network 912 and user device 918, are examples of base station site 102, control device 110, packet data network 120 and user device 118, as respectively described above with reference to FIGS. 1 and 2. Control device 910 includes, first interface(s) 914 and policy engine/traffic control engine 904. First interface(s) 914 and policy engine/traffic control engine 904 are examples of first interface(s) 302 and policy engine/traffic control engine 308, as respectively described above with reference to FIG. 3. Other structural and operational embodiments will be apparent to persons skilled in the relevant art(s) based on the following discussion regarding flowchart 800 and system 900 shown in FIG. 9.

Flowchart 800 begins with step 802. At step 802, a determination is made that a user device has communicatively coupled to a wireless access point located at the base station site. For example, with reference to FIG. 9, control device 910 determines that user device 918 is communicatively coupled to wireless access point 906 located at base station site 902.

In accordance with one or more embodiments, the control device may determine that the user device is communicatively coupled to the wireless access point by determining a device identifier of the user device, retrieving user credentials associated with the user of the user device based on the device identifier, authenticating the user device based on the retrieved user credentials, and determining that the user device has connected to the wireless access point upon successfully authenticating the user device. For example, with reference to FIG. 9, user device 918 may provide wireless access point 906 an authentication request 901. Authentication request 901 may include a device identifier (e.g., a MAC ID) of user device 918. Wireless access point 906 may provide authentication request 901 and/or the user credentials to control device 910 via first interface(s) 914. Control device 910 may retrieve user credentials (e.g., a user name and password) associated with the user of user device 918 based on the device identifier. For example, control device 910 may access a database that associates device identifiers with different user credentials. The database may be stored by control device 910 or in a data store maintained by base station site 902. Alternatively, the database may be remotely located at a server (e.g., server 104, as shown in FIG. 1), and control device 910 may access the server to determine the user credentials. Upon determining the user credentials, control device 910 attempts to automatically authenticate user device by providing the credentials to wireless access point 906. If the authentication is successful, control device 910 may determine that user device 918 is communicatively coupled to wireless access point 906.

At step 804, a second data policy is associated with the user device is determined. For example, with reference to FIG. 9, policy engine/traffic control engine 904 may determine the second data policy associated with user device 918. For example, policy engine/traffic control engine 904 may access a database that associates a data policy (or policies) with different user device(s) using a device identifier of user device 918 to determine the second data policy. The database may be stored by control device 910 or in a data store maintained by base station site 902. Alternatively, the database may be remotely located at a server (e.g., server 104), and control device 910 may access server to determine the second data policy.

At step 806, a request for data is received from the user device. For example, with reference to FIG. 9, user device 918 may send a data request 903 to wireless access point 906. Wireless access point 906 provides data request 903 to control device 910 via first interface(s) 914. First interface(s) 914 provides data request 903 to packet data network 912.

At step 808, the data is retrieved and provided to the user device in accordance with the determined second data policy. For example, packet data network 912 provides a response 905 that includes the requested data to control device 910 via first interface(s) 914. First interface(s) 914 provides response 905 to wireless access point 906 in accordance with the data policy determined by policy engine/traffic control engine 904. Wireless access point 906 provides response 905 to user device 918.

In accordance with one or more embodiments, the second data policy specifies at least an amount of bandwidth to be allocated to the user device when accessing data via the wireless access point, one or more metering rules for billing a subscriber associated with the user device based on an amount of data downloaded by the user device via the wireless access point, or whether data downloaded via the wireless access point affects a usage quota of the user device.

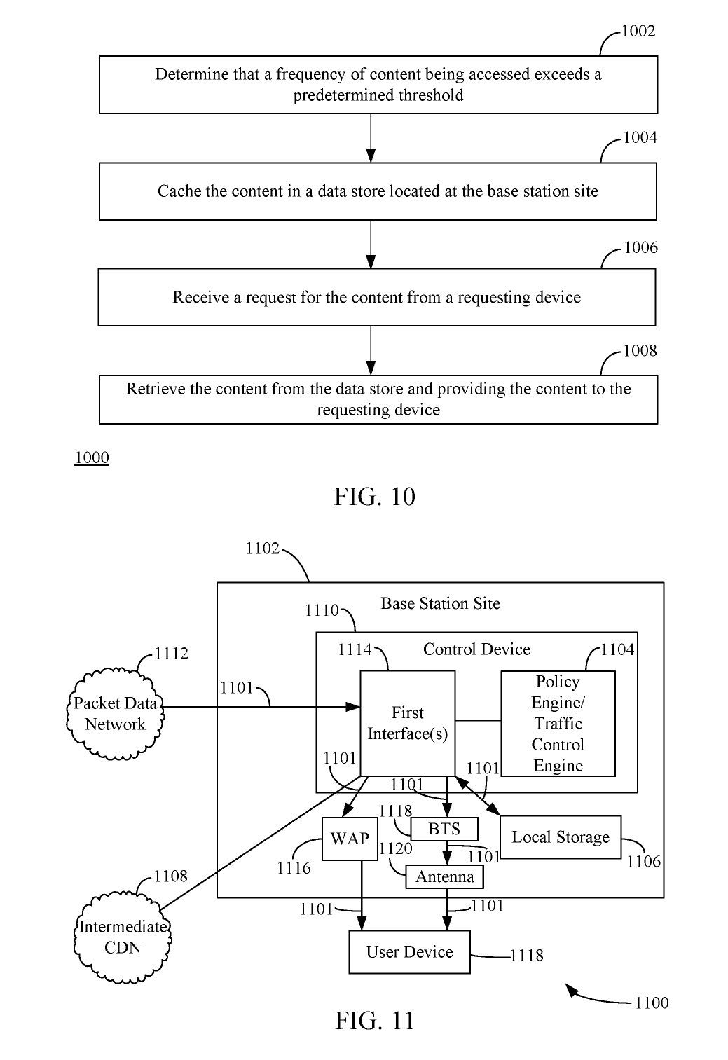

In accordance with one or more embodiments, the control device may be configured to cache data that is frequently access by user device(s). For example, FIG. 10 shows a flowchart 1000 of a method performed by a control device for caching data in accordance with another embodiment. The method of flowchart 1000 may be implemented by control device 1110 shown in FIG. 11. FIG. 11 is a block diagram of a system 1100 for caching data, in accordance with another embodiment. As shown in FIG. 11, system 1100 includes a base station site 1102 and a user device 1118. Base station site 1102 includes a control device 1110, a wireless access point 1116, a BTS 1118 and an antenna 1120. Control device 1110 includes first interface(s) 1114 and policy engine/traffic control engine 1104. As shown in FIG. 11, control device 1110 is communicatively coupled to a packet data network 1112 and/or an intermediate content delivery network (CDN) 1108 via first interface(s) 1114. Base station site 1102, control device 1110, packet data network 1112, user device 1118, wireless access point 1116, BTS 1118 and antenna 1120, are examples of base station site 102, control device 110, packet data network 120, user device 118, wireless access point 202, BTS 108 and antenna 112, as respectively described above with reference to FIGS. 1 and 2. First interface(s) 1114 and policy engine/traffic control engine 1104 are examples of first interface(s) 302 and policy engine/traffic control engine 308, as respectively described above with reference to FIG. 3. Other structural and operational embodiments will be apparent to persons skilled in the relevant art(s) based on the following discussion regarding flowchart 1000 and system 1100 shown in FIG. 11.

Flowchart 1000 begins with step 1002. At step 1002, a determination is made that a frequency of content being accessed exceeds a predetermined threshold. For example, with reference to FIG. 11, policy engine/traffic control engine 1104 may be configured to monitor the frequency of content 1101 provided to user device 1118 via packet data network 1112. For example, policy engine/traffic control engine 1104 may maintain a counter as to how many times a particular piece of content has been accessed (e.g., played, downloaded, streamed, etc.) from a particular web page or web site maintained by packet data network 1112 by user device 1118 (either via wireless access point 1116 or BTS 1118 and antenna 1120). If the counter exceeds a predetermined threshold, then policy engine/traffic control engine 1104 may determine that the frequency of content being accessed has exceeded the predetermined threshold. It is noted that other caching techniques may be used cache content.

At step 1004, the content is cached in a data store located at the base station site. For example, with reference to FIG. 11, the content may be stored locally in local storage 1106. Local storage may comprise one or more data stores (e.g., memories, hard drives, and/or any other type of storage device described herein). Alternatively, the content may be cached in intermediate CDN 1108, which may comprise data store(s) for storing the content. Intermediate CDN 1108 may be located relatively close base station site 1102 (than compared to servers maintained by packet data network 1112). Thus, caching the content in either intermediate CDN 1108 or in local storage 1106 advantageously reduces latency when compared to accessing content from packet data network 1112.

At step 1006, a request for the content is received from a requesting device. For example, with reference to FIG. 11, user device 1118 may provide a request for content 1101 (either via wireless access point 1116 or antenna 1120 and BTS 1118).

At step 1008, the content is retrieved from the data store and provided to the requesting device. For example, with reference to FIG. 11, policy engine/traffic control engine 1104 determines that the requested content (i.e., content 1101) is cached in local storage 1106 (or alternatively, in intermediate CDN 1108), and control device 1110 retrieves the content from local storage 1106 via first interface(s) 1114, and provides content 1101 to user device 1118 (either via wireless access point 1116 or antenna 1120 and BTS 1118).

B. Central Analyzer

FIG. 12 is a block diagram of an architecture of central analyzer 1200 in accordance with an embodiment. Central analyzer 1200 is an example of central analyzer 122, as described above with reference to FIG. 1. As shown in FIG. 12, central analyzer 1200 comprises an interface layer 1202, a virtualization layer 1204, a platform layer 1206 and an application layer 1208. Interface layer 1202 comprises a control device interface 1210, an operations support systems (OSS) interface 1212 and a third-party software and systems interface 1214. Control device interface 1210 is configured to communicate with a plurality (e.g., millions) of control devices (e.g., control device 110, as shown in FIG. 1), and in turn a plurality (e.g., billions) of devices (e.g., first device(s) 114 and/or second device(s) 116). Communication via control device interface 1210 may be in accordance with one or more protocols, including, but not limited to, a REST or RESTful protocol, a DIAMETER protocol, an OpenFlow protocol, an SNMP protocol, etc. OSS interface 1212 is configured to communicate with the OSS of one or more telecom vendors. Third party software and systems interface 1214 is configured to communicate with one or more of enterprise resource planning (ERP) software (e.g., Systems, Applications and Products (SAP) software), email servers, short message system (SMS) gateways, supply chain management software, external databases and/or any other standard or proprietary office-based tools or software. Interface layer 1202 may also provide security mechanisms to ensure that all internal and external communications are effectively secure.

Virtualization layer 1204 may enable execution of central analyzer 1200 in a virtualized environment, which could scale up or scale down to handle any number of control devices (via scaling logic 1216). Virtualization layer 1204 may also be configured to meet certain performance criteria (via performance logic 1218) (e.g., handling an M number of transactions per second and/or having a response time of N milli-seconds, where M and N are any positive integer).

Platform layer 1206 may comprise policy detection and application logic 1220, housekeeping logic 1228, web portal logic 1222, operating graphical user interface (GUI) logic 1224, and steering logic 1226. Policy detection and application logic 1220 may comprise the core intelligence and computing of the NOC software. Policy detection and application logic 1220 may comprise a decision engine that is configured to decide whether a service can be offered or be denied. The decision engine may receive input (e.g., a request) from a service requesting entity, compare the request with the service policies/constraints provisioned by the stakeholders, and provide the decision about policy level feasibility. Based on the policy level feasibility, the application function initiates a service request as required. This advantageously provides value added service creation/modification/deletion (among other service management operations), and also creates records related to the service's data consumption, denials, service creation issues, etc.

Housekeeping logic 1228 may comprise middleware that implements one or more services, such as a command line interface (CLI), logger services, a Simple Network Management Protocol (SNMP) agent and its associated adaption layer, High Availability (HA) functions and a Management & Orchestration (MANO) interface. These services may be used in functional logic such as steering logic 1226, policy decision and application logic 1220, etc. The foregoing may be deployed as a VNF (Virtual Network Function) in one or more VMs (virtual machines), with each VM having at least one VNFC (Virtual Network Function Component). This VNFC may comprise two or more of policy detection and application logic 1220, web portal logic 1222, operator GUI logic 1224 and/or steering logic 1226.

Web portal logic 1222 may be configured to present required information to the MNOs, to which the application function is connected. Web portal logic 1222 may provide web-based interfaces and functionalities for all those entities/persons other than user/operator of the application function, providing multiple ways for MNOs to state their tariff and related rules, monitor issues relating to services offered by the network elements. Web portal logic 1222 may also support many analytics relating to any services and billing. For example, the information indicative of the data usage may be securely displayed to the content provider, the MNO and/or other entities (e.g., the content distributor). The displayed web portal may also be used for commercial billing of the user equipment by the MNO, the content provider and/or the content distributor. For example, the displayed web portal may be used as an electronic commerce (e-commerce) portal for the MNO, the content provider and/or the content distributor.

Operator GUI logic 1224 may be configured to enable the content distributor or content provider to configure web portal logic 1222 dynamically for their needs. This function may provide the web based interface and GUI to the users, which may comprise an Element Management System (EMS) for Fault, Configuration, Accounting, Performance, and Security (FCAPS) functionality, web pages to provision the system with business policies, a plurality of dash boards to analyze application generated data (relating to service offerings) and billing information.

Steering logic 1226 may be configured to route incoming packets to the destination as commanded by policy detection and application logic 1220. Steering logic 1226 may be a collection of protocol interfaces and their end-point(s). The protocol end-points may be DIAMETER-based state-machines, such as Rx, Gx, and/or REST interfaces. Protocol messages may be sent to the applications layer or any other functional blocks of the system. This mapping between protocol messages and functional blocks may be controlled by an internal message routing entity, and the functional blocks of the system may be designed to receive/send generic messages. Hence, the steering function may provide an adaptation function along with the mapping function. Steering logic 1226 directly interconnects with interface layer 1202.

Application layer 1208 may comprise related or unrelated applications running over platform layer 1206. Depending on the requirements of the applications, virtualization layer 1204 scales out or scales in. Examples of applications includes, but are not limited to, a bandwidth optimizer 1230, a Wi-Fi offloader 1232, and a cell manager 1234. Bandwidth optimizer 1230 may implement a policy for each traffic flow based on user identity, domain, application or any other parameter in lieu of or in addition to policy engine/traffic control engine 308, as described above with reference to FIG. 3. The policy may be defined by the stakeholders or it could operate in conjunction with the Mobile Network's Policy. The policy may be, but not limited to, widening or constricting the bandwidth provided to any individual traffic flow on the mobile network (e.g., mobile network 106, as shown in FIG. 1). Bandwidth optimizer 1230 may be configured to, in conjunction with the control device, or with an application running on a mobile device (e.g., user device 118, as shown in FIG. 1), may map any user to a specific IP address. Bandwidth optimizer 1230 may also be configured to perform metering of the traffic per user, domain and application, may communicate with the OCS and OFCS of the MNO via the Gy and Gz interfaces and provides various detailed analytics. In accordance with an embodiment, bandwidth optimizer 1230 may optimize the bandwidth to optimize video content being provided to a user device. Additional details regarding such video optimization may be found in U.S. patent application Ser. No. 15/385,594 (entitled “Systems and Methods for Providing Improved Quality of Experience for Media Content Consumption” and filed on Dec. 20, 2016), the entirety of which is incorporated by referenced herein.

Wi-Fi offloader 1232, may be configured to implement a policy for each traffic flow associated with a wireless access point located at a particular base station based on user identity, domain, application or any other parameter in lieu of or in addition to policy engine/traffic control engine 308, as described above with reference to FIG. 3. The policy may be, but not limited to, widening or constricting the bandwidth provided to any individual traffic flow on the Wi-Fi network. The policy may be defined by the stakeholders, or it could operate in conjunction with the mobile network's policy. Wi-Fi offloader may, by itself, or in conjunction with the control device, communicate to the MNO through a backbone network to obtain the user credentials to authenticate the user so that the user does not need to enter any authentication credentials user to enter the Wi-Fi network from a mobile network. Wi-Fi offloader 1232 may be configured to, by itself, or in conjunction with a control device, map any user to a specific IP address. Wi-Fi offloader 1232, by itself, or in conjunction with a control device, may also perform metering of the traffic per user, domain and application, and provides various detailed analytics. Wi-Fi offloader 1232 may also manage the mobile data usage quota of the user by itself, or in conjunction with the control device, as per the plan provided by the MNO, effectively and seamlessly (e.g., if the user's usage quota has to be decremented even though the user has entered a Wi-Fi network from a mobile network, or if the user's usage quota does not need to be decremented when the user has entered a Wi-Fi network from a mobile network).

Cell manager 1234 may be configured to perform various functions. Such functions include, but are not limited to: (a) data processing for logging, alarm and event generation for all the IoT and non-IoT devices (e.g., first device(s) 114 and/or second device(s) 116) as well as the control devices connected remotely; (b) data storage for the processing, remote site details, alarm and events as described above; (c) provisioning a GUI for visualization of display parameters including but not limited to, electricity, diesel, air-conditioning, battery, fuel cell or solar power consumption and for monitoring the health of each of these systems; (d) trouble ticketing and its closure (manual and/or automatic) and customer relations management; (e) maintenance management, site upgradation, including scheduling site visits by authorized personnel including Role Based Access control; (f) using inputs gathered from the control device, process them and take intelligent decisions on activating/de-activating specific functionalities automatically in the remote sites, for example, starting of diesel generators and/or air conditioners when the site temperature rises above a certain threshold, and automatically alerting responsible personnel following a defined hierarchy when certain thresholds (for example, fuel level falling below a certain level) are reached; (g) SLA (service-level agreement) management; (g) provisioning an interface to ERP for purchase order generation, processing contract agreements, payment settlement; (h) provisioning an RF interface, transmission planning tools for cell site planning and optimization; (i) data analytics and report generation for different stakeholders in the ecosystem; (j) providing an interface to operations management center (OMC)-R (radio), OMC-S (switch), OSS, NOC, GNOC or other similar tools/software; and/or (k) asset management.

### III. Example Computer System Implementation

The components of the control device shown in FIGS. 1-3, 5, 7, 9, and 11, the components of the server shown in FIGS. 1, 2, 5, and 12, and/or the methods of FIGS. 4, 6, 8, and 10, may be implemented in hardware, or any combination of hardware with software and/or firmware. For example, the components of the control device shown in FIGS. 1-3, 5, 7, 9, and 11, the components of the server shown in FIGS. 1, 2, 5, and 12, and/or the methods of FIGS. 4, 6, 8, and 10 may be implemented as computer program code configured to be executed in one or more processors. In another example, the components of the control device shown in FIGS. 1-3, 5, 7, 9, and 11, the components of the server shown in FIGS. 1, 2, 5, and 12, and/or the methods of FIGS. 4, 6, 8, and 10 may be implemented as hardware (e.g., hardware logic/electrical circuitry), or any combination of hardware with software (computer program code configured to be executed in one or more processors or processing devices) and/or firmware.

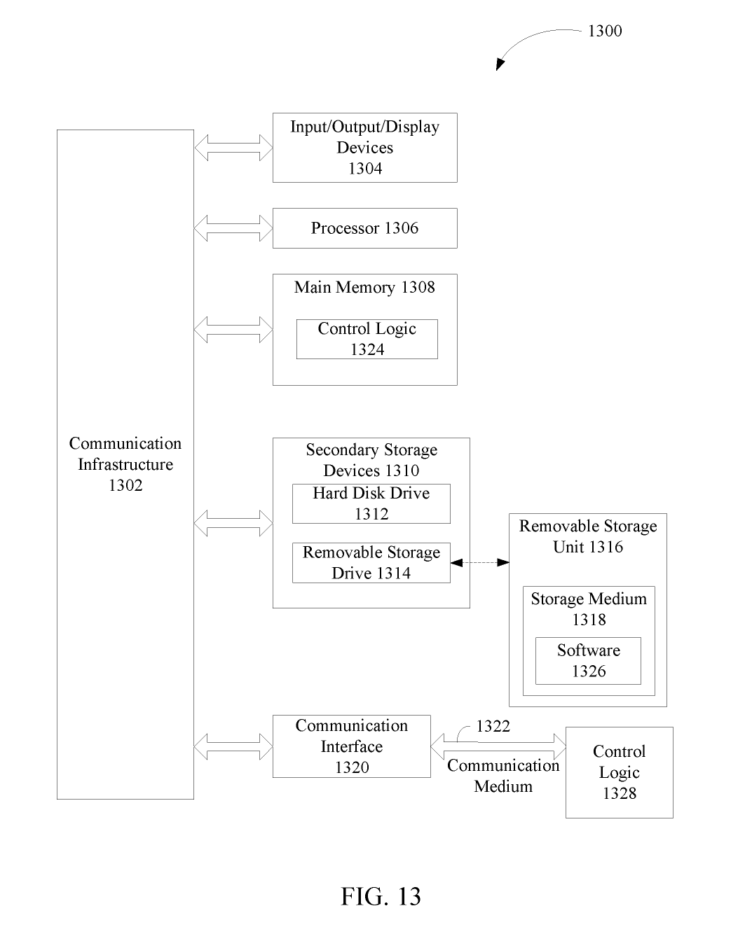

The embodiments described herein, including systems, methods/processes, and/or apparatuses, may be implemented using well known servers/computers, such as computer 1300 shown in FIG. 13. For example, the control device shown in FIGS. 1-3, 5, 7, 9, and 11 and/or the server shown FIGS. 1, 2, and 5 can each be implemented using one or more computers 1300.

Computer 1300 can be any commercially available and well known computer capable of performing the functions described herein, such as computers available from International Business Machines, Apple, Sun, HP, Dell, Cray, etc. Computer 1300 may be any type of computer, including a desktop computer, a server, etc.

As shown in FIG. 13, computer 1300 includes one or more processors (also called central processing units, or CPUs), such as a processor 1306. Processor 1306 may be used to implement certain elements of the control device shown in FIGS. 1-3, 5, 7, 9, and 11, certain elements of the server shown FIGS. 1, 2, 5, and 12, and/or the methods of FIGS. 4, 6, 8, and 10; or any portion or combination thereof, for example, though the scope of the embodiments is not limited in this respect. Processor 1306 is connected to a communication infrastructure 1302, such as a communication bus. In some embodiments, processor 1306 can simultaneously operate multiple computing threads.

Computer 1300 also includes a primary or main memory 1308, such as random access memory (RAM). Main memory 1308 has stored therein control logic 1324 (computer software), and data.

Computer 1300 also includes one or more secondary storage devices 1310. Secondary storage devices 1310 may include, for example, a hard disk drive 1312 and/or a removable storage device or drive 1314, as well as other types of storage devices, such as memory cards and memory sticks. For instance, computer 1300 may include an industry standard interface, such a universal serial bus (USB) interface for interfacing with devices such as a memory stick. Removable storage drive 1314 may represent a floppy disk drive, a magnetic tape drive, a compact disk drive, an optical storage device, tape backup, etc.

Removable storage drive 1314 may interact with a removable storage unit 1316. Removable storage unit 1316 includes a computer useable or readable storage medium 1318 having stored therein computer software 1326 (control logic) and/or data. Removable storage unit 1316 represents a floppy disk, magnetic tape, compact disc (CD), digital versatile disc (DVD), Blu-ray™ disc, optical storage disk, memory stick, memory card, or any other computer data storage device. Removable storage drive 1314 reads from and/or writes to removable storage unit 1316 in a well-known manner.

Computer 1300 also includes input/output/display devices 1304, such as monitors, keyboards, pointing devices, etc.

Computer 1300 further includes a communication or network interface 1320. Communication interface 1320 enables computer 1300 to communicate with remote devices. For example, communication interface 1320 allows computer 1300 to communicate over communication networks or mediums 1322 (representing a form of a computer useable or readable medium), such as local area networks (LANs), wide area networks (WANs), the Internet, etc. Communication interface 1320 may interface with remote sites or networks via wired or wireless connections. Examples of communication interface 1322 include but are not limited to a modem, a network interface card (e.g., an Ethernet card), a communication port, a Personal Computer Memory Card International Association (PCMCIA) card, etc.

Control logic 1328 may be transmitted to and from computer 1300 via the communication medium 1322.

Any apparatus or manufacture comprising a computer useable or readable medium having control logic (software) stored therein is referred to herein as a computer program product or program storage device. This includes, but is not limited to, computer 1300, main memory 1308, secondary storage devices 1310, and removable storage unit 1316. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing certain elements of the control device shown in FIGS. 1-3, 5, 7, 9, and 11, certain elements of the server shown FIGS. 1, 2, 5, and 12, and/or the methods of FIGS. 4, 6, 8, and 10 and/or further embodiments described herein. Embodiments of the invention are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

It is noted that while FIG. 13 shows a server/computer, persons skilled in the relevant art(s) would understand that embodiments/features described herein could also be implemented using other well-known processor-based computing devices, including but not limited to, smart phones, tablet computers, netbooks, gaming consoles, personal media players, and the like.

### IV. Conclusion

In accordance with an embodiment, any combination of the above-described embodiments may be utilized depending on the system being implemented.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method performed by a control device located at a base station site configured to, at least in part, implement a mobile network, comprising:
receiving, via one or more first interfaces of the control device, one or more parameters from one or more first devices communicatively coupled to the control device, the one or more first devices being located at the base station site; and
performing at least one of:
determining one or more first actions to be performed with respect to one or more second devices located at the base station site based on the received one or more parameters and providing, via the one or more first interfaces, one or more first commands to the one or more second devices that cause the one or more second devices to perform the one or more first actions; or
providing, via one or more second interfaces, the one or more parameters to a centralized server via the mobile network;
receiving, via the one or more second interfaces, one or more second commands from the centralized server, the second commands being determined based on the one or more parameters;
translating the one or more second commands into a format suitable for processing by the one or more second devices; and
providing the translated one or more second commands to the one or more second devices via the one or more first interfaces, the translated one or more second commands causing the one or more second devices to perform one or more second actions.

2. The method of claim 1, wherein the centralized server is communicatively coupled to a plurality of control devices, each of the plurality of control devices being located at a respective base station site.

3. The method of claim 1, wherein the one or more first interfaces comprise at least one or more of:
a Universal Serial Bus (USB) interface;
a coaxial interface;
an Ethernet interface;
a Recommended Standard (RS)-232 interface;
an RS-485 interface;
an RS-422 interface;
a Modbus interface;
an infrared (IR) communication interface;
a Bluetooth™ communication interface;
a ZigBee® communication interface;
an radio frequency (RF)-based communication interface; or
a wireless local area network-based interface.

4. The method of claim 1, wherein the one or more second interfaces comprise at least one or more of:
a REST protocol-based interface;
a DIAMETER protocol-based interface;
an OpenFlow protocol-based interface; or
an SNMP protocol-based interface.

5. The method of claim 1, wherein the one or more first devices comprise at least one or more of:
a fuel level sensor;
a fuel tank lid sensor;
a lube oil pressure sensor;
a diesel generator vibration sensor;
a temperature sensor;
a voltage sensor;
a current sensor;
a humidity sensor;
a motion sensor;
a fire sensor; or
a smoke sensor.

6. The method of claim 1, wherein the one or more second devices comprise at least one or more of:
a camera;
a fan;
a door;
a thermostat;
an air conditioning unit;
a generator; or
an antenna.

7. The method of claim 1, wherein the one or more first commands are provided to the one or more second devices responsive to the received one or more parameters exceeding a predetermined threshold.

8. A method performed by a control device located at a base station site configured to, at least in part, implement a mobile network, comprising:
determining that a user device has communicatively coupled to a base station located at the base station site;
determining a first data policy associated with the user device;
receiving a request for data from the user device; and
retrieving and providing the data to the user device in accordance with the determined first data policy.

9. The method of claim 8, further comprising:
determining that a user device has communicatively coupled to a wireless access point located at the base station site;
determining a second data policy associated with the user device;
receiving a second request for data from the user device; and
retrieving and providing the data to the user device in accordance with the determined second data policy.

10. The method of claim 9, wherein determining that the user device has connected to the wireless access point comprises:
determining a device identifier of the user device;
retrieving user credentials associated with the user of the user device based on the device identifier;
authenticating the user device based on the retrieved user credentials; and
determining that the user device has connected to the wireless access point upon successfully authenticating the user device.

11. The method of claim 8, further comprising:
determining that a frequency of content being accessed exceeds a predetermined threshold;
caching the content in a data store located at the base station site;
receiving a request for the content from a requesting device; and
retrieving the content from the data store and providing the content to the requesting device.

12. The method of claim 8, wherein the first data policy specifies at least one of:
an amount of bandwidth to be allocated to the user device when accessing data; or
one or more metering rules for billing a subscriber associated with the user device based on an amount of data downloaded by the user device.

13. The method of claim 8, wherein the second data policy specifies at least one of:
an amount of bandwidth to be allocated to the user device when accessing data via the wireless access point;
one or more metering rules for billing a subscriber associated with the user device based on an amount of data downloaded by the user device via the wireless access point; or
whether data downloaded via the wireless access point affects a usage quota of the user device.

14. A control device located at a base station site configured to, at least in part, implement a mobile network, comprising:
a processing unit; and
a memory coupled to the one or more processing units, the memory storing instructions, which, when executed by the one or more processing units, cause the one or more processing units to perform operations, the operations comprising:
receiving, via one or more first interfaces of the control device, one or more parameters from one or more first devices communicatively coupled to the control device, the one or more first devices being located at the base station site; and
performing at least one of:
determining one or more first actions to be performed with respect to one or more second devices located at the base station site based on the received one or more parameters and providing, via the one or more first interfaces, one or more first commands to the one or more second devices that cause the one or more second devices to perform the one or more first actions; or
providing, via one or more second interfaces, the one or more parameters to a centralized server via the mobile network;
receiving, via the one or more second interfaces, one or more second commands determined based on the one or more parameters from the centralized server;
translating the one or more second commands into a format suitable for processing by the one or more second devices; and
providing the translated one or more second commands to the one or more second devices via the one or more first interfaces, the translated one or more second commands causing the one or more second devices to perform one or more second actions.

15. The control device of claim 14, wherein the centralized server is communicatively coupled to a plurality of control devices, each of the plurality of control devices being located at a respective base station site.

16. The control device of claim 14, wherein the one or more first interfaces comprise at least one or more of:
a Universal Serial Bus (USB) interface;
a coaxial interface;
an Ethernet interface;
a Recommended Standard (RS)-232 interface;
an RS-485 interface;
an RS-422 interface;
a Modbus interface;
an infrared (IR) communication interface;
a Bluetooth™ communication interface;
a ZigBee® communication interface;
an radio frequency (RF)-based communication interface; or
a wireless local area network-based interface.

17. The control device of claim 14, wherein the one or more second interfaces comprise at least one or more of:
a REST protocol-based interface;
a DIAMETER protocol-based interface;
an OpenFlow protocol-based interface; or
an SNMP protocol-based interface.

18. The control device of claim 14, wherein the one or more first devices comprise at least one or more of:
a fuel level sensor;
a fuel tank lid sensor;
a lube oil pressure sensor;
a diesel generator vibration sensor;
a temperature sensor;
a voltage sensor;
a current sensor;
a humidity sensor;
a motion sensor;
a fire sensor; or
a smoke sensor.

19. The control device of claim 14, wherein the one or more second devices comprise at least one or more of:
a camera;
a fan;
a door;
a thermostat;
an air conditioning unit;
a generator; or
an antenna.

20. The control device of claim 14, wherein the one or more first commands are provided to the one or more second devices responsive to the received one or more parameters exceeding a predetermined threshold.
